(19) United States
(12) Patent Application Publication
(10) Pub. No.: US 2021/0123496 A1
(43) Pub. Date: Apr. 29, 2021

(54) SUPPORT DAMPING APPARATUS AND VEHICLE USING SUPPORT DAMPING APPARATUS

(71) Applicant: Gang CHEN, Haikou (CN)

(72) Inventor: Gang CHEN, Haikou (CN)

(21) Appl. No.: 17/139,074

(22) Filed: Dec. 31, 2020

Related U.S. Application Data
(63) Continuation of application No. PCT/CN2019/086920, filed on May 14, 2019.

(30) Foreign Application Priority Data
Jul. 29, 2018 (CN) 201810850830.1
Jul. 29, 2018 (CN) 201821209280.7

(51) Int. Cl. F16F 13/00; F16F 9/34; F16F 9/53; F16F 9/512

(52) U.S. Cl. CPC F16F 13/007; F16F 9/512; F16F 9/53; F16F 9/34

(57) ABSTRACT

The present invention relates to a support damping apparatus and a vehicle using the support damping apparatus. The support damping apparatus includes a support spring, a force measuring element and a damper. The damper includes a hydraulic cylinder, a valve assembly and a control assembly. The force measuring element measures a support force value of the support damping apparatus for a supported object, and compares the support force value with a target force value. The damping force value of the damper is controlled by the control assembly in a mechanical, hydraulic or electric manner according to a comparison result so as to adjust the support force value of the support damping apparatus, so that the support force value of the support damping apparatus is equal to or approximate to the target force value. The present invention also relates to a vehicle with the support damping apparatus.

### CROSS-REFERENCE TO RELATED APPLICATIONS

This application is a continuation of International Application No. PCT/CN2019/086920, filed on May 14, 2019, which claims the benefit of priority from Chinese Patent Application No. 201821209280.7, filed on Jul. 29, 2018, and Chinese Patent Application No. 201810850830.1, filed on Jul. 29, 2018. The content of the aforementioned applications, including any intervening amendments thereto, is incorporated herein by reference.

### TECHNICAL FIELD

The present invention relates to support and damping of an object which requires vibration control or vibration damping, and particularly relates to a support damping apparatus and a vehicle using the support damping apparatus.

### BACKGROUND OF THE PRESENT INVENTION

To make vehicles drive stably under different pavement conditions, a hanging and damping method of the vehicles is very important. Conventional dampers are classified into passive, semi-active (adjustable) and active dampers.

Passive dampers: the conventional hanging and damping method using the cooperation of springs and the damper belongs to the passive vibration damping. Once after the damper is designed and mounted, a damping force value is determined and cannot be adjusted with the load change, so that the vibration in a vehicle driving process cannot be better filtered out in the application process.

Semi-active dampers: the semi-active dampers are not widely used and can adjust the damping under certain conditions, but the cost is relatively high, and the maintenance is difficult; and moreover, the effect for filtering the vibration in the vehicle driving process is rather limited.

Active dampers: the active dampers are rarely used. By means of a computer-aided measurement and control technology, the effect is relatively good, but the cost is very high, the reliability is insufficient, the maintenance is difficult, and the technical difficulty is great.

The method for controlling or damping the vibration of the object used at present is similar to a vehicle damping method, belongs to the passive vibration damping, and cannot actively adjust the vibration absorption damping according to stress conditions of the object.

### SUMMARY OF THE PRESENT INVENTION

On this basis, it is necessary to provide a support damping apparatus and a vehicle using the support damping apparatus, so that a damper can automatically adjust a damping force value according to a stress condition of a support spring and the damper on an object supported thereby in a vibration process and reduce the impact of an external force on the support force value of the object supported by the support spring and the damper in a driving process of a vehicle, thereby reducing or eliminating the vibration. Particularly, when the vehicle drives on an uneven pavement, the vibration and bumping of the vehicle caused by the unevenness of the pavement in the driving process can be reduced.

A force measuring element is used to measure the support force value of the support damping apparatus for the supported object. A control assembly compares the support force value with a target force value and controls the damping force value of the damper in a mechanical, hydraulic or electric manner according to a comparison result so as to adjust the support force value of the support damping apparatus, so that the support force value of the support damping apparatus is equal to or approximate to the target force value. The target force value refers to a set force value or a gravity value of the object supported by the support damping apparatus, and can also be called a benchmark force value or a reference force value. The support force value of the support damping apparatus refers to a resultant force value of the support force value of the support spring on the supported object and the support force value of the damper on the supported object together in the support force direction. The support force value of the damper and the support spring on the supported object can be directly measured by the single force measuring element. The support force value of the support spring on supported object and the support force value of the damper on supported object can be separately measured by two force measuring elements to calculate the support force value of the support damping apparatus through the control assembly. The measurement of the support force value of the support damping apparatus is not limited to the above two methods.

Solution 1: a support damping apparatus includes a support spring, a force measuring element and a damper. The damper includes a hydraulic cylinder, a valve assembly and a control assembly. The force measuring element is used to measure a support force value of the support damping apparatus for a supported object. The control assembly is used to compare the support force value with a target force value, and control the damping force value of the valve assembly according to the comparison result so as to adjust the stretching damping force value or compression damping force value of the damper, thereby adjusting the support force value of the support damping apparatus, so that the support force value of the support damping apparatus is equal to or approximate to the target force value.

A damping adjusting method is as follows:

When the support force value of the support damping apparatus is greater than the target force value, and the damper is in a stretching process (the hydraulic cylinder changes from short to long), increasing the stretching damping force value of the damper; and when the support force value of the support damping apparatus is less than the target force value, and the damper is in the stretching process (the hydraulic cylinder changes from short to long), decreasing the stretching damping force value of the damper;

Or

When the support force value of the support damping apparatus is greater than the target force value, and the damper is in a compression process (the hydraulic cylinder changes from long to short), decreasing the compression damping force value of the damper; and when the support force value of the support damping apparatus is less than the target force value, and the damper is in the compression process (the hydraulic cylinder changes from long to short), increasing the compression damping force value of the damper.

The support damping apparatus is an apparatus with a support function and a vibration damping function. A pillar-type damper with a support spring and a damper, a combination of an air spring and a damper using an air hanging system, a combination of a load bearing spring and a damper with the load bearing spring and the damper arranged separately, and a support damping system herein composed of an energy storage device, a pressure reducing valve, an overflow valve and a single-action hydraulic cylinder all belong to the support damping apparatus.

The support spring refers to an elastic component with an energy storage function, such as a spiral spring, a disc spring, a compressed air energy storage device, an air spring, etc. The support spring is a main component playing a support role in the support damping apparatus. The compressed air energy storage device plays a support role together with the hydraulic cylinder in the support damping apparatus herein.

Hydraulic cylinder and the damper: the hydraulic cylinder is composed of a piston, a piston rod, a cylinder barrel and the like. The hydraulic cylinder includes a single-action hydraulic cylinder, a double-action hydraulic cylinder, etc. The damper is formed by the hydraulic cylinder, the valve assembly, the control assembly and the like. The damper includes a conventional single-barrel damper, double-barrel damper and magneto-rheological damper, and also includes an apparatus with a vibration damping function composed of the hydraulic cylinder, the valve assembly, the control assembly and other separate elements, such as the dampers composed of the pressure reducing valve or the overflow valve and the hydraulic cylinder used in the solution 5, solution 6 and partial solutions in embodiments herein. The single-action hydraulic cylinder and the double-action hydraulic cylinder playing the support role together with the energy storage device have a function in the support damping apparatus for transferring energy of the energy storage device through liquid flow, that is, the pressure of the energy storage device is converted into mechanical energy by the hydraulic cylinder so as to bear the gravity of the supported object. The main function of the single-barrel damper and the double-barrel damper in the support damping apparatus is to generate hydraulic damping so as to attenuate the vibration. A stretching cavity of the single-barrel or double-barrel damper refers to a cavity with a piston rod in the two cavities that are already separated by a piston. When the damper is stretched, the volume of the stretching cavity is reduced. A compression cavity of the single-barrel or double-barrel damper refers to a cavity without the piston rod in the two cavities that are already separated by the piston. When the damper is compressed, the volume of the stretching cavity is reduced.

The valve assembly refers to a component having an effect for damping and closing the liquid flow or air flow or controlling a direction of the liquid flow and includes a throttling valve, a one-way valve, a pressure reducing valve, an overflow valve, a magneto-rheological damper, an electro-rheological damper, an electromagnetic valve, a damper bottom valve, a valve on the damper piston, etc. The electric control valve herein refers to one of the magneto-rheological damper, the electro-rheological damper and the electromagnetic valve. A main function of the valve assembly in the support damping apparatus is to generate damping for the liquid flow or control the direction of the liquid flow.

When the support damping apparatus with the magneto-rheological damper or the electro-rheological damper is used, a hydraulic medium is corresponding magneto-rheological liquid or electro-rheological liquid.

The force measuring element refers to a component that can be used to measure the support force value of the support damping apparatus or set the target force value, such as a compressed air spring, a spiral spring, a disc spring, a force sensor and relevant circuit assemblies thereof, a pressure sensor and relevant circuit assemblies thereof. The spring for setting or adjusting the pressure also belongs to the force measuring element, such as a pressure regulating spring of the pressure reducing valve and the overflow valve. When the single force measuring element directly measures the support force value of the support damping apparatus for the supported object, one end of the force measuring element (such as the force sensor or the force measuring spring) is connected to a mounting end connected with the supported object, and the other end of the force measuring element is connected to the support spring and the damper of the support damping apparatus. When a plurality of force measuring elements directly measure the support force value of the support damping apparatus, one end of the force measuring elements can be connected to the mounting end connected with the object supported by the support damping apparatus, and the other ends of the force measuring elements are connected respectively to the support spring and the damper. When the force measuring elements indirectly measure the support force value of the support damping apparatus, the force measuring elements are the pressure regulating springs of the overflow valve or the pressure reducing valve. A force measuring method of the force measuring element is not limited to the above.

The control assembly refers to an intermediate action component that can be mechanically, electrically or hydraulically linked with the force measuring element to directly or indirectly adjust the damping of the valve assembly. The control assembly may be a mechanical component and may also be an electronic circuit device. For example, when the valve assembly is the electro-rheological damper or magneto-rheological damper and the electromagnetic valve, the control assembly is the electronic circuit device. The control assembly shown in FIG. 1, FIG. 3 and FIG. 5 may include a control linkage. One end of the control linkage is connected to the mounting end connected with the object supported by the support damping apparatus, and the other end of the control linkage is connected to a slide valve located in a piston inner cavity of the piston. The control assembly plays a role in adjusting the position of the slide valve according to the support force value of the support damping apparatus and driving the slide valve to move up and down to enlarge or narrow a valve port, thereby controlling the damping force value of the valve assembly. The control assembly shown in FIG. 7 and FIG. 8 may also include a valve core on the valve reducing valve or the overflow valve. The liquid flow pressure of the hydraulic cylinder acts on the valve core and transfers the force to the force measuring spring, thereby adjusting the position of the valve core, and controlling the damping force value of the pressure reducing valve or the overflow valve. The control assembly shown in FIG. 9, FIG. 10 and FIG. 11 may also include a controller. The controller is connected with the force sensor and the electric control valve through an electric signal and receives the force value information of the force sensor and controls the damping force value of the electric control valve.

The pressure reducing valve and the overflow valve in examples herein are a combination of the valve assembly, the force measuring element and the control assembly. The pressure reducing valve and the overflow valve both have the functions of the valve assembly, the force measuring element and the control assembly. The pressure reducing valve herein compares the target pressure value set by the pressure regulating spring with the liquid flow pressure in the hydraulic cylinder, and controls the damping force value of the pressure reducing valve according to the comparison result, thereby controlling the pressure of the liquid flow entering the hydraulic cylinder, so that the support force value of the hydraulic cylinder can be controlled. The overflow valve herein compares the pressure set by the pressure regulating spring with the liquid flow pressure of the hydraulic cylinder, and adjusts the damping force value of the overflow valve for the liquid flow according to the comparison result, thereby controlling the pressure of the liquid flow flowing out of the hydraulic cylinder, so that the support force value of the hydraulic cylinder can be controlled. The damping force value of the pressure reducing valve is controlled by the pressure at an outlet of the pressure reducing valve, and the damping force value of the overflow valve is controlled by the pressure at an inlet of the overflow valve. That is, the pressure regulating springs of the pressure reducing valve and the overflow valve play a role in indirectly measuring the support force value of the support damping apparatus by measuring the liquid flow pressure in the hydraulic cylinder. The force of the pressure regulating springs of the pressure reducing valve and the overflow valve directly acts on the valve cores of the pressure reducing valve and the overflow valve and interacts with the pressure at an inlet and an outlet of the hydraulic cylinder to adjust the damping force value of the pressure reducing valve and the overflow valve. The pressure reducing valve and the overflow valve belong to the hydraulic adjusting type, that is, the pressure value of the liquid flow in the hydraulic cylinder controls the damping force value of the pressure reducing valve and the overflow valve.

The pressure reducing valve, the overflow valve and the one-way valve herein are not limited to the conventional pressure reducing valve, overflow valve and one-way valve. Any assembly or assembly combination having the same function with the pressure reducing valve, the overflow valve and the one-way valve is construed as being equivalent to the pressure reducing valve, overflow valve and one-way valve herein.

Solution 2: (FIG. 1 and FIG. 2) preferably, in the support damping apparatus as described in the solution 1: the control assembly includes a control linkage, and a force measuring element includes the force measuring spring; a piston of a damper is integrated with a valve assembly, and the valve assembly includes a one-way valve and a slide valve; and one end of the force measuring spring is mounted on a mounting end of the support damping apparatus, and the other end of the force measuring spring is mounted on a support spring and connected with the support spring in series. The support spring and the damper are coaxially mounted and connected in parallel. The other end of the control linkage connected with the mounting end penetrates through the piston rod and is connected to the slide valve in the piston. When the force measuring spring is stretched or compressed, the slide valve connected to the control linkage is directly driven to move so as to form a damping hole with different diameters with a valve hole on the piston, thereby achieving a purpose of controlling the damping force value. The force measuring spring measures the support force value of the support damping apparatus and adjusts the position of the slide valve through the control linkage according to a measured value, thereby adjusting the damping force value of the valve assembly in the stretching process. When in compression, the liquid flow in the compression cavity flows to the stretching cavity via the one-way valve on the piston.

Solution 3: (FIG. 3 and FIG. 4) preferably, in the support damping apparatus as described in the solution 1: the control assembly is a control linkage, and a bottom valve of the damper is integrated with a valve assembly. The valve assembly includes a one-way valve and a slide valve, and the force measuring element includes a force measuring spring; one end of the force measuring spring is mounted on a mounting end of the support damping apparatus, and the other end of the force measuring spring is connected with the damper in series. The support spring and the damper are coaxially mounted and connected in parallel. The other end of the control linkage connected with the mounting end is connected to the slide valve arranged in the bottom valve. When the force measuring spring is stretched or compressed, the slide valve connected to the control linkage is directly driven to move to form a damping hole with different diameters with a valve hole on the bottom valve, thereby achieving a purpose of controlling the damping force value. The force measuring spring measures the support force value of the support damping apparatus, and adjusts the damping force value of the valve assembly in the compression process by the control linkage according to a measured value. When in stretching, the liquid flow in a liquid storage cavity flows to a compression cavity via the one-way valve on the bottom valve.

Solution 4: (FIG. 5 and FIG. 6) preferably, in the support damping apparatus as described in the solution 1: the piston of the damper is integrated with a valve assembly. The valve assembly includes two one-way valves and a slide valve. The piston is also integrated with a piston inner cavity. One one-way valve is communicated with a stretching cavity, and the other one-way valve is communicated with a compression cavity. The control assembly includes a control linkage. The other end of the control linkage connected with a mounting end penetrates through a piston rod and is connected to the slide valve in the piston inner cavity. The force measuring element includes a force measuring spring. One end of the force measuring spring is mounted on the mounting end of the support damping apparatus, and the other end of the force measuring spring is connected with the damper in series. The support spring and the damper are coaxially mounted and connected in parallel. When the force measuring spring is stretched or compressed, the slide valve on the control linkage is directly driven to move to form a damping hole with different diameters with a valve hole on the piston inner cavity, thereby achieving a purpose of controlling the damping force value. The support damping apparatus also includes a liquid storage device. The piston inner cavity is communicated with the liquid storage device. When the damper is compressed or stretched, the force measuring spring measures a support force value of the support damping apparatus and adjusts a damping force value of a stretching valve and a compression valve through the control linkage according to a measured value. When the volume of the stretching cavity or compression cavity of the damper increases, the liquid flow is compensated by the one-way valve.

Solution 5: (FIG. 7) preferably, in the support damping apparatus as described in solution 1: a hydraulic cylinder is a single-action hydraulic cylinder. A support spring includes an energy storage device, and a valve assembly includes a pressure reducing valve and a one-way valve. The force measuring element includes a force measuring spring arranged on the pressure reducing valve. The control assembly includes a valve core on the pressure reducing valve. The energy storage device is connected with an oil inlet of the pressure reducing valve and an oil outlet of the one-way valve. The single-action hydraulic cylinder is connected with an oil outlet of the pressure reducing valve and an oil inlet of the one-way valve. When the single-action hydraulic cylinder is compressed, the liquid flow in the single-action hydraulic cylinder flows into the energy storage device via the one-way valve. When the single-action hydraulic cylinder is stretched, the pressure of the liquid flow entering the single-action hydraulic cylinder is compared with a set target pressure value of the pressure reducing valve so as to adjust the damping force value of the pressure reducing valve, so that the pressure of the liquid flow entering the single-action hydraulic cylinder from the energy storage device is not greater than the set force value, thereby limiting the increase of the support force of the single-action hydraulic cylinder. The target pressure value refers to a liquid pressure value when the support force value of the hydraulic cylinder is equal to the target value, that is, the support force value of the hydraulic cylinder reaches the pressure value required by the target force value.

Solution 6: (FIG. 8) preferably, in the support damping apparatus as described in solution 1: the hydraulic cylinder is a single-action hydraulic cylinder (20). A support spring includes an energy storage device. A valve assembly includes an overflow valve and a one-way valve. A force measuring element includes a force measuring spring arranged on the overflow valve. A control assembly includes a valve core on the overflow valve. The energy storage device is connected with an oil outlet of the overflow valve and an oil inlet of the one-way valve, and the single-action hydraulic cylinder is connected with an oil inlet of the overflow valve and an oil outlet of the one-way valve. When the single-action hydraulic cylinder (20) is stretched, the liquid flow in the energy storage device flows to the single-action hydraulic cylinder via the one-way valve. When the single-action hydraulic cylinder is compressed, the pressure of the liquid flow flowing out of the single-action hydraulic cylinder is compared with the target pressure value of the overflow valve so as to adjust the damping force value of the overflow valve. The overflow valve makes the pressure of the liquid flow flowing out of the single-action hydraulic cylinder not less than the target pressure value, thereby preventing the decrease of the support force value of the single-action hydraulic cylinder.

Solution 7: (FIG. 9, FIG. 10 and FIG. 11) preferably, in the support damping apparatus as described in the solution 1: the force measuring element includes a force sensor. A control assembly includes a controller. A valve assembly includes an electric control valve. At least one of a piston and a bottom valve of a damper is provided with an electric control valve. The controller receives an electric signal of the force sensor and transmits a control signal to the electric control valve. When the piston or the bottom valve of the damper is provided with a one-way valve, at least one force sensor should be mounted to measure a resultant force of the support damping apparatus. When the piston or the bottom valve of the damper is not provided with the one-way valve, at least two force sensors should be mounted to measure the resultant force of the support damping apparatus and calculate whether a stress state of the damper is a pulling force or pressure. The controller compares the resultant force of the support damping apparatus measured by the force sensor with the target force value and controls the damping force value of the electric valve according to a comparison result and the stress state of the damper.

A control method of the support damping apparatus of an electrically-controlled damping type is as follows:

1. When a support force value of the support damping apparatus is greater than a target force value: if the force on a damper is a pulling force (the damper changes from short to long), increasing a stretching damping force value of the damper (increasing the damping force value of an electric control valve); and

If the force on the damper is pressure (the damper changes from long to short), decreasing a compression damping force value of the damper (reducing the damping force value of the electric control valve).

2. When the support force value of the support damping apparatus is less than the target force value:

If the force on the damper is the pulling force (the damper changes from short to long), decreasing the stretching damping force value of the damper (reducing the damping force value of the electric control valve); and

If the force on the damper is pressure (the damper changes from long to short), increasing the compression damping force value of the damper (increasing the damping force value of the electric control valve).

3. When the support force value of the support damping apparatus is approximate to or equal to the target force value, maintaining the current damping force value of the damper.

The stretching valve of the damper refers to the valve by which the liquid flow flows out of the stretching cavity of the hydraulic cylinder when the damper is stretched. The compression valve of the damper refers to the valve by which the liquid flow flows out of the compression cavity of the hydraulic cylinder when the damper is compressed.

Solution 8: (FIG. 9) preferably, in the support damping apparatus as described in the solution 7: a force sensor includes a force sensor A for measuring a support force value of a support spring and a force sensor B for measuring a pulling force or pressure value of the hydraulic cylinder. A current resultant force of the support spring and the hydraulic cylinder on the support damping apparatus is calculated through measured values of the force sensor A and the force sensor B, and a stress state of the hydraulic cylinder is judged. The controller controls the damping force value of an electric control valve according to the resultant force of the support damping apparatus and the stress state of the hydraulic cylinder. The resultant force of the support damping apparatus herein is the resultant force of the support force value of the support spring and the pulling force or pressure value of the hydraulic cylinder, i.e. the support force value of the support damping apparatus.

A damping control method is as follows:

1. When a resultant force of the support damping apparatus is greater than the gravity of an object supported by the support damping apparatus and a force on a hydraulic cylinder is pressure (the damper changes from long to short), decreasing the damping force value of an electric valve on a piston and a bottom valve;

2. When the resultant force of the support damping apparatus is greater than the target force value and the force on the hydraulic cylinder is a pulling force (the damper changes from short to long), increasing the damping force value of the electric control valve on the piston, and decreasing the damping force value of the electric control valve on the bottom valve;

3. When the resultant force of the support damping apparatus is less than the target force value and the force on the hydraulic cylinder is pressure (the damper changes from long to short), increasing the damping force value of the electric control valve on the hydraulic cylinder bottom valve, and decreasing the damping force value of the electric control valve on the piston; and

4. When the resultant force of the support damping apparatus is less than the target force value and the force on the hydraulic cylinder is a pulling force (the damper changes from short to long), decreasing the damping force value of the electric control valves on the piston and the bottom valve.

Solution 9: (FIG. 11) preferably, in the support damping apparatus as described in the solution 7:

The valve assembly includes an electric control valve and a one-way valve. The electric control valve and the one-way valve are mounted on a piston. The bottom valve has no electric control valve, that is, the bottom valve is the bottom valve of a conventional single-barrel or double-barrel damper, and the one-way valve on the piston is connected with the electric control valve in parallel. The control assembly includes a controller. A force sensor is the force sensor A. The controller receives an electric signal of the force sensor A and controls the damping force value of the electric control valve. The force sensor A measures a resultant force of the support spring and the hydraulic cylinder on the support damping apparatus. The control assembly compares the resultant force of the support damping apparatus measured by the force sensor A with the target force value and controls the damping force value of the electric control valve according to a comparison result. The resultant force of the support damping apparatus herein refers to the resultant force of the support force value of the support spring and the pulling force or pressure value of the hydraulic cylinder, i.e. the support force value of the support damping apparatus.

A damping control method is as follows:

when the resultant force of the support damping apparatus is less than the target force value, decreasing the damping force value of the electric control valve on the piston; and

when the resultant force of the support damping apparatus is greater than the target force value, increasing the damping force value of the electric control valve on the piston.

When the hydraulic cylinder is compressed, a liquid medium flows into a stretching cavity via the one-way valve on the piston. When the hydraulic cylinder is stretched, the liquid medium flows out of the stretching cavity via the electric control valve on the piston.

Solution 10: in the support damping apparatus as described in the solutions 2, 3, and 4: the position of the control linkage is adjustable in the vertical direction, that is, an initial position of a slide valve can be adjusted in the vertical direction by adjusting a control linkage. The damping force value of the valve assembly of the support damping apparatus under different loads and the critical value when the valve assembly is opened or closed can be changed by adjusting the position of the control linkage so as to adapt to different load states.

Solution 11: a vehicle such as a vehicle with a single wheel, two wheels, three wheels or multiple wheels adopts one of the support damping apparatuses described in the above solutions 1-10.

The present invention has the beneficial effects:

Compared with the existing self-adaptive damping technology, the support damping apparatus has better self-adaptive damping function. The damping force value of the support damping apparatus can be automatically adjusted according to a fluctuation state of the pavement, so that the damping effect is better, the structure is simpler, the control process and control method are relatively simple, and the cost is lower.

### BRIEF DESCRIPTION OF THE DRAWINGS

FIG. 1 is a schematic diagram of a support damping apparatus of a spring-support stretching damping controlled type.

FIG. 2 is an enlarged view of a valve assembly part in the schematic diagram of FIG. 1.

FIG. 3 is a schematic diagram of a support damping apparatus of a spring-support compression damping controlled type.

FIG. 4 is an enlarged view of a valve assembly part in the schematic diagram of FIG. 3.

FIG. 5 is a schematic diagram of a support damping apparatus of a spring-support stretching and compression damping double-controlled type.

FIG. 6 is an enlarged view of a valve assembly part in the schematic diagram of FIG. 5.

FIG. 7 is a schematic diagram of a support damping apparatus of a hydraulic/pneumatic-support stretching damping controlled type.

FIG. 8 is a schematic diagram of a support damping apparatus of a hydraulic/pneumatic-support compression damping controlled type.

FIG. 9 is a schematic diagram 1 of a support damping apparatus of an electric control damping type.

FIG. 10 is a schematic diagram 2 of the support damping apparatus of the electric control damping type.

FIG. 11 is a schematic diagram 3 of the support damping apparatus of the electric control damping type.

### REFERENCE NUMERALS IN THE DRAWINGS

1-Control linkage; 2-force measuring spring; 3-piston rod
4-support spring; 5-stretching cavity; 6-one-way valve
7-Piston; 8-slide valve; 9-compression cavity
10-Bottom valve; 11-separation piston; 12-gas storage chamber
13-Liquid flow path on a bottom valve when in stretching; 14-liquid flow path on the bottom valve when in compression
15-Liquid flow path on a piston when in compression; 16-liquid flow path on the piston when in stretching
17-Hydraulic cylinder; 18-liquid storage cavity; 19-energy storage device (compressed air spring)
20-single-action hydraulic cylinder; 21-pressure reducing valve; 22-liquid storage device
23-Overflow valve; 24-controller; 25-force sensor (measuring pressure)
26-Force sensor (measuring a pulling force and pressure); 27-signal or control conductor
30-Electric control valve
31-Piston inner cavity; 32-liquid inlet/outlet flow path
100-Force measuring element; 200-damper; 300-valve assembly
400-Control assembly; 500-compression valve; 600-stretching valve
700-Force sensor

### DETAILED DESCRIPTION OF THE PRESENT INVENTION

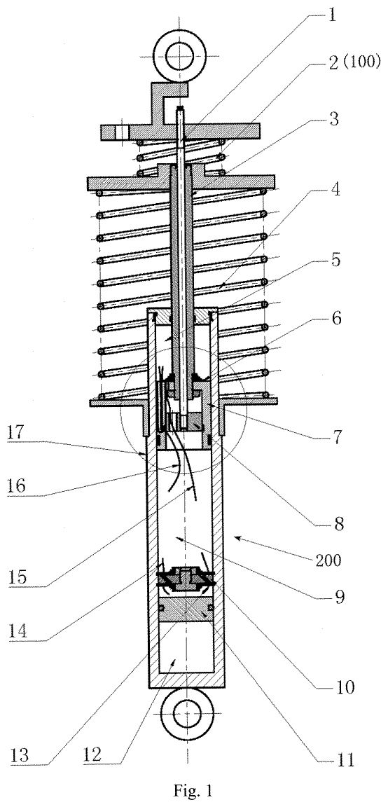

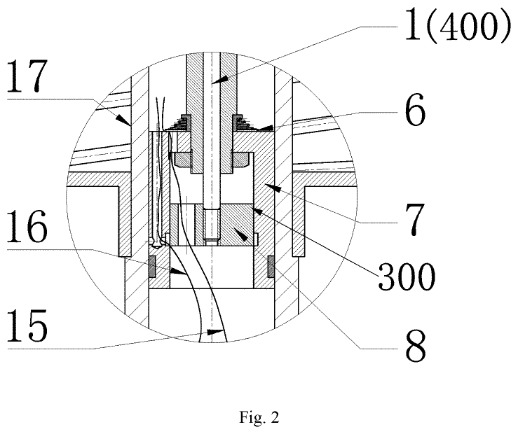

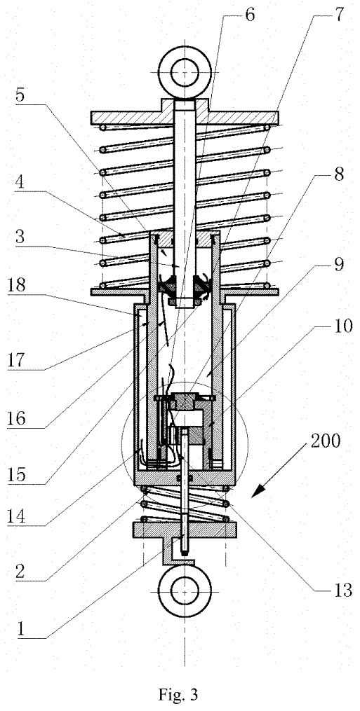

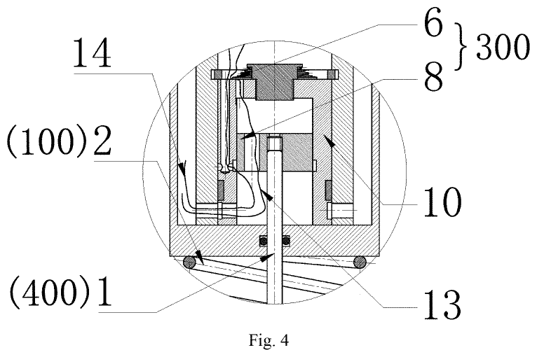

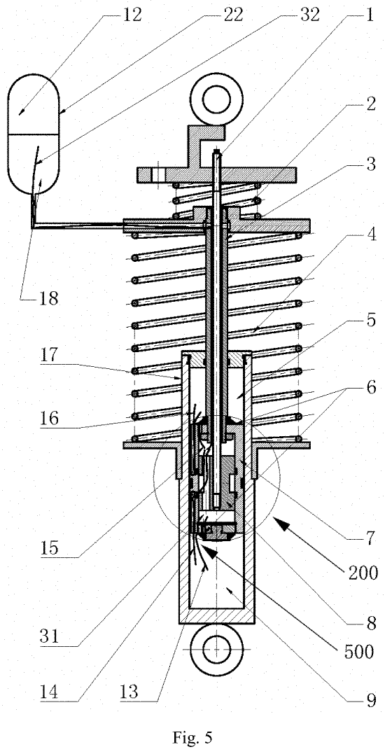

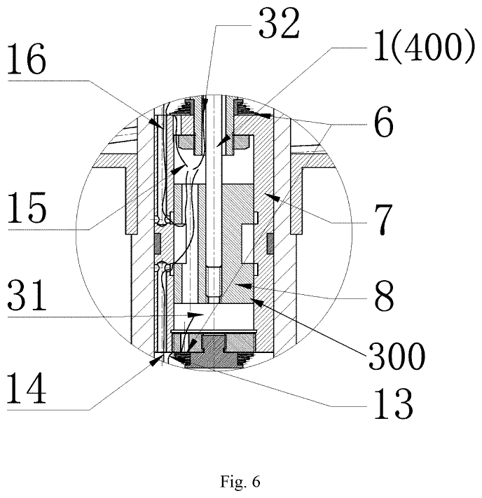

Preferred solution 1: FIG. 1, FIG. 2, FIG. 3. FIG. 4, FIG. 5 and FIG. 6 illustrate schematic diagrams of a support damping apparatus of a spring-support stretching or (and) compression damping controlled type.

The support damping apparatus includes a force measuring spring 2, a support spring 4 and a damper 200. The damper 200 includes a hydraulic cylinder 17, a bottom valve 10, a piston 7, a valve assembly 300 and a control linkage 1. The valve assembly 300 includes a one-way valve 6 and a slide valve 8. The slide valve 8 is arranged on the bottom valve 10 or the piston 7 and linked with the control linkage 1. The one-way valve 6 is arranged on the bottom valve 10 and the piston 7. When the support force value of the support damping apparatus for a supported object measured by the force measuring spring 2 is changed, the control linkage 1 may drive the slide valve 8 to move up and down, so that an openness of a valve port of the slide valve 8 and the piston 7 or the bottom valve 10 increases or decreases, thereby changing a damping force value of the valve assembly 300.

A working principle:

For the support damping apparatus as shown in FIG. 1 and FIG. 2: when the support damping apparatus is compressed under stress, the liquid flow can flow through the one-way valve 6 on the piston 7 and the one-way valve 6 on the bottom valve 10 via a liquid flow path 14 on the bottom valve when in compression and a liquid flow path 15 on the piston when in compression. When the support damping apparatus is transformed from compression to stretching, the support force value decreases, the force measuring spring 2 changes from short to long, and the control linkage 1 and the slide valve 8 on the control linkage 1 are driven to move from bottom to top. When the support force value of the support damping apparatus decreases gradually from greater than the target force value to less than the target force value (the force measuring spring 2 changes from short to long), and a valve port of the stretching valve 600 (the valve port by which the liquid flow path 16 on the piston flows when in stretching is the valve port of the stretching valve 600) is changed gradually from a closed position to a fully opened position of the stretching valve 600, and the damping force value of the stretching valve 600 decreases. When the support force value of the support damping apparatus increases gradually from less than the target force value to greater than the target force value (the force measuring spring 2 changes from long to short), and the support damping apparatus is in a stretching process, the slide valve 8 moves from top to bottom, the valve port of the stretching valve 600 (the valve port by which the liquid flow path 16 on the piston flows by when in stretching is the valve port of the stretching valve 600) gradually decreases in a through diameter, and the damping force value of the stretching valve 600 increases.

For the support damping apparatus shown in FIG. 3 and FIG. 4:

When the support damping apparatus is stretched, the liquid flow can flow through the one-way valve 6 on the bottom valve 10 and the one-way valve 6 on the piston 7 via a liquid flow path 13 on the bottom valve when in stretching and a liquid flow path 16 on the piston when in stretching. When the support damping apparatus is compressed under stress, the support force value of the support damping apparatus increases, the force measuring spring 2 changes from long to short, and the control linkage 1 and the slide valve 8 on the control linkage 1 are driven to move from bottom to top. When the support force value of the support damping apparatus increases gradually from less than the target force value to greater than the target force value (the force measuring spring 2 changes from long to short), a valve port of the compression valve 500 (the valve port by which the liquid flow path 14 on the bottom valve flows when in compression is the valve port of the compression valve 500) is gradually changed from a closed position to a fully opened position of the compression valve 500, and the damping force value of the compression valve 500 decreases. When the support force value of the support damping apparatus decreases gradually from greater than the target force value to less than the target force value (the force measuring spring 2 changes from short to long), and the support damping apparatus is in a compression process, the slide valve 8 moves from top to bottom, the valve port of the compression valve 500 (the valve port by which the liquid flow path 14 on the bottom valve flows when in compression is the valve port of the compression valve 500) decreases gradually in a through diameter, and the damping force value of the compression valve 500 increases.

For the support damping apparatus as shown in FIG. 5 and FIG. 6: when the support damping apparatus is stretched, the support force value of the support damping apparatus decreases, the force measuring spring 2 changes from short to long, and the control linkage 1 and the slide valve 8 on the control linkage 1 are driven to move from bottom to top. When the support force value of the support damping apparatus decreases gradually from greater than the target force value to less than the target force value (the force measuring spring 2 changes from short to long), the valve port of the stretching valve 600 (the valve port by which the liquid flow path 16 on the piston flows when in stretching is the valve port of the stretching valve 600) is changed from a closed position to a fully opened position, and the damping force value of the stretching valve 600 decreases. When the support force value of the support damping apparatus increases gradually from less than the target force value to greater than the target force value (the force measuring spring 2 changes from long to short), and the support damping apparatus is in the stretching process, the slide valve 8 moves from top to bottom, a valve port of the stretching valve 600 (the valve port by which the liquid flow path 16 on the piston flows when in stretching is the valve port of the stretching valve 600) decreases gradually in a through diameter, and the damping force value of the stretching valve 600 increases. When the support damping apparatus is compressed, the support force value of the support damping apparatus increases, the force measuring spring 2 changes from long to short, and the control linkage 1 and the slide valve 8 on the control linkage 1 are driven to move from top to bottom. When the support force of the support damping apparatus increases gradually from less than the target force value to greater than the target force value (the force measuring spring 2 changes from long to short), the valve port of the compression valve 500 (the valve port by which the liquid flow path 14 on the bottom valve flows when in compression is the valve port of the compression valve 500) is changed from the closed position to the fully opened position, and the damping force value of the compression valve 500 decreases. When the support force value of the support damping apparatus decreases gradually from greater than the target force value to less than the target force value (the force measuring spring 2 changes from short to long), and when the support damping apparatus is in the compression process, the slide valve 8 moves from bottom to top, the valve port of the compression valve 500 (the valve port by which the liquid flow path 14 on the bottom valve flows when in compression is the valve port of the compression valve 500) decreases gradually in the through diameter, and the damping force value of the compression valve 500 increases. When the support damping apparatus is stretched, the liquid flow flows into the compression cavity 9 through the one-way valve 6 via the liquid flow path 13 on the bottom valve when in stretching. When the support damping apparatus is compressed, the liquid flow flows into the stretching cavity 5 through the one-way valve 6 via the liquid flow path 15 on the piston when in compression. The liquid flow during the stretching and compression of the support damping apparatus flows into or out of the liquid storage device 22 through a liquid inlet/outlet flow path 32.

The control linkage 1 shown in FIG. 1, FIG. 3 and FIG. 5 can be adjusted up and down. The position of the slide valve 8 can be adjusted by adjusting the position of the control linkage 1, so that a critical support force value of the support damping apparatus when the valve port of the compression valve 500 or the stretching valve 600 is opened and closed can be adjusted.

Preferred solution 2:

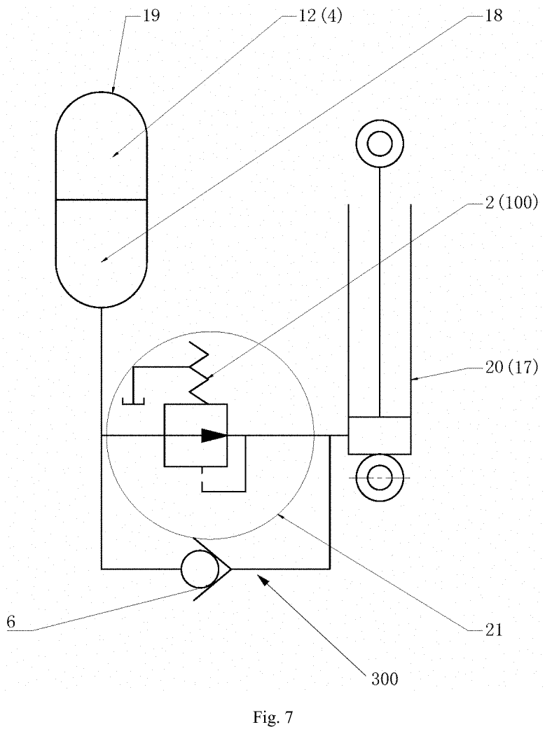

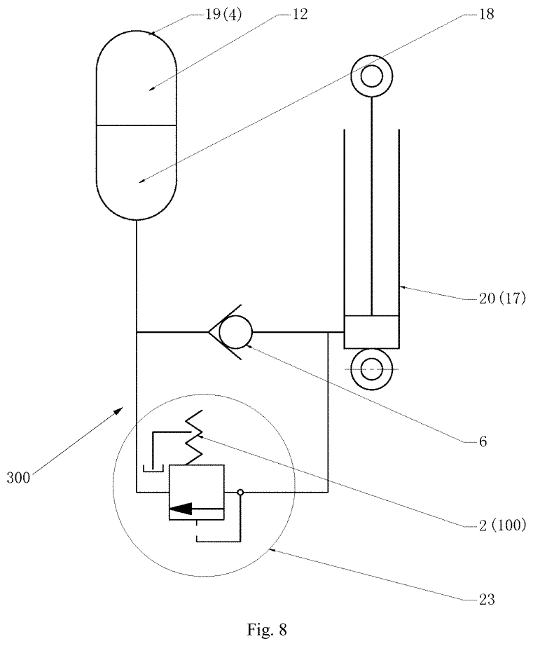

FIG. 7 and FIG. 8 illustrate schematic diagrams of a support damping apparatus of a hydraulic-support stretching or compression damping controlled type:

The support damping apparatus includes an energy storage device 19, a single-action hydraulic cylinder 20, a pressure reducing valve 21, an overflow valve 23 and a one-way valve 6. Pressure regulation springs of the pressure reducing valve 21 and the overflow valve 23 can set the pressure of the liquid flow entering or flowing out of the single-action hydraulic cylinder 20. The pressure of the liquid flow entering or flowing out of the single-action hydraulic cylinder 20 is compared with the set target pressure value, thereby indirectly measuring the support force of the single-action hydraulic cylinder 20. The damping force value of valve ports of the pressure reducing valve 21 and the overflow valve 23 is adjusted according to a comparison result, thereby adjusting the pressure of the liquid flow entering or flowing out of the single-action hydraulic cylinder 20. The above pressure regulation spring is equivalent to the force measuring spring 2.

A working principle:

For the support damping apparatus shown in FIG. 7: when the single-action hydraulic cylinder 20 is retracted under the stress, the liquid flow may flow into the energy storage device 19 via the one-way valve 6. When the hydraulic cylinder is stretched, the pressure reducing valve 21 makes the pressure of the liquid flow entering the hydraulic cylinder from the energy storage device not greater than the set target pressure value, thereby limiting the increase of the support force value of the single-action hydraulic cylinder 20. That is, when the single-action hydraulic cylinder 20 is in the stretching process and the support force value is less than the target force value (the pressure of the liquid flow is less than the set target pressure value), the liquid flow damping force value of the pressure reducing valve 21 decreases; and when the single-action hydraulic cylinder 20 is in the stretching process and the support force value is greater than the target force value (the pressure of the liquid flow is greater than the set target pressure value), the liquid flow damping force value of the pressure reducing valve 21 increases. When the single-action hydraulic cylinder 20 is compressed, the liquid flow can flow back to the energy storage device 19 from the single-action hydraulic cylinder 20 via the one-way valve 6.

For the support damping apparatus shown in FIG. 8: when the single-action hydraulic cylinder 20 is stretched, the liquid flow in the energy storage device 19 flows to the single-action hydraulic cylinder 20 via the one-way valve 6. When the single-action hydraulic cylinder 20 is compressed, the overflow valve 23 makes the pressure of the liquid flow flowing out of the hydraulic cylinder not less than the set target pressure value, thereby preventing the decrease of the support force value of the hydraulic cylinder. That is, when the single-action hydraulic cylinder 20 is in the compression process and the support force value is less than the target force value (the pressure of the liquid flow is less than the set target pressure value), the liquid flow damping force value of the overflow valve 23 increases; and when the single-action hydraulic cylinder 20 is in the compression process and the support force value is greater than the target force value (the pressure of the liquid flow is greater than the set target pressure value), the liquid flow damping force value of the overflow valve 23 decreases. When the single-action hydraulic cylinder 20 is stretched, the liquid flow can flow back to the single-action hydraulic cylinder 20 from the energy storage device 19 via the one-way valve 6.

Preferred solution 3:

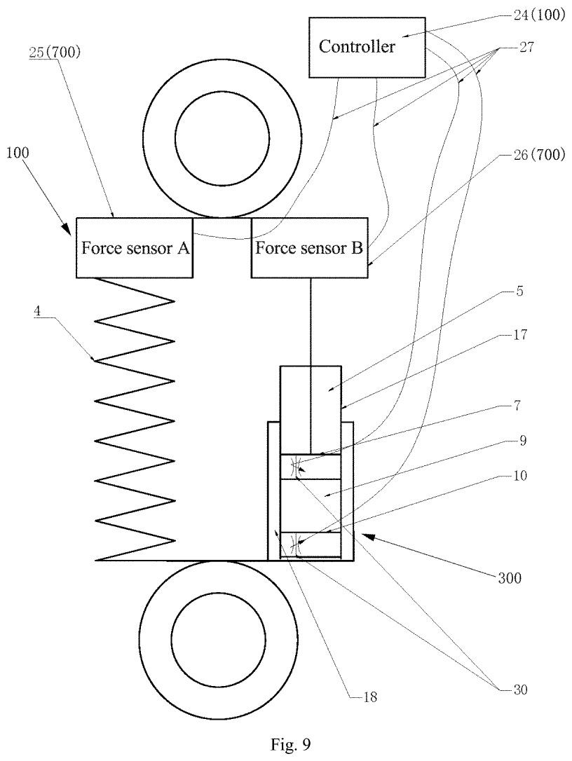

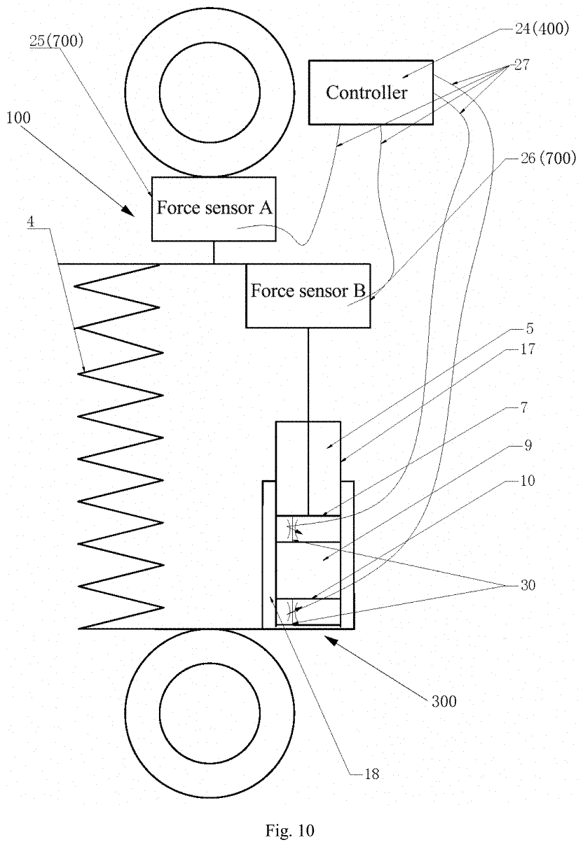

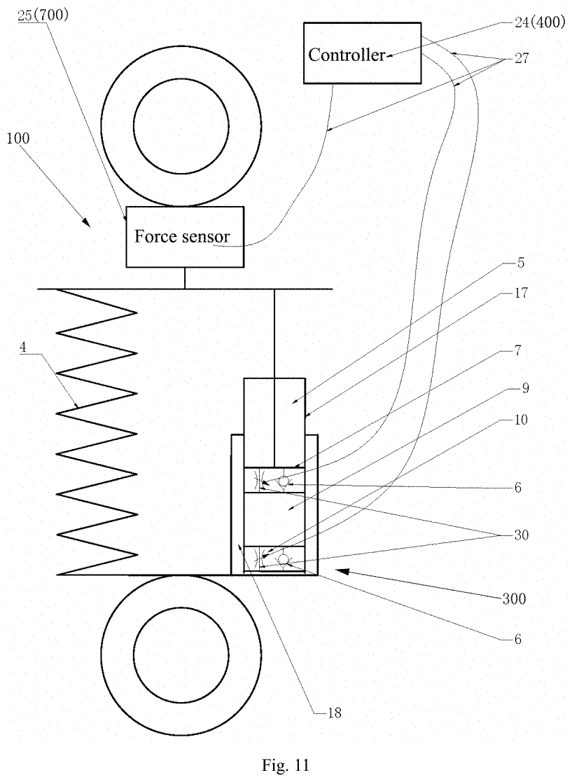

FIG. 9, FIG. 10 and FIG. 11 illustrate schematic diagrams of a support damping apparatus of an electric control damping type.

The support damping apparatus includes a force measuring element 100, a support spring 4, a hydraulic cylinder 17, an electric control valve 30 and a controller 24. The electric control valve 30 is mounted on a bottom valve 10 or a piston 7 of the damper. The force measuring element 100 is composed of a force sensor 700 and relevant circuit elements. The controller 24 is composed of electronic circuit elements. The controller 24 plays a role in calculating a measured value of the force sensor 700 and controlling the damping force value of the electric control valve 30 (the electric control valve 30 refers to an electromagnetic valve, a magneto-rheological damper, an electro-rheological damper, etc.). In the support damping apparatus of a stretching or (and) compression damping controlled type shown in FIG. 9 and FIG. 10, at least one of the bottom valve 10 or the piston 7 is provided with the electric control valve 30. In the support damping apparatus of the stretching or (and) compression damping controlled type shown in FIG. 11, at least one of the bottom valve 10 or the piston 7 is provided with the electric control valve 30 and the one-way valve 6.

A working principle:

For the support damping apparatus shown in FIG. 9: the force sensor A 25 measures the support force value of the support spring 4. The force sensor B 26 measures the pulling force or pressure value of the hydraulic cylinder 17.

For the support damping apparatus shown in FIG. 10: the force sensor A 25 measures a resultant force of the support spring 4 and the hydraulic cylinder 17. The force sensor B 26 measures the pulling force or pressure value of the hydraulic cylinder damper 17.

For the support damping apparatus shown in FIG. 11:

The force sensor A 25 measures the resultant force of the support spring 4 and the hydraulic cylinder 17. The piston 7 or (and) the bottom valve 10 is provided with both the electric control valve 30 and the one-way valve 6.

In the subsequent description of the working state, the control signal outputted by the controller 24 is only suitable for controlling the piston 7 with the electric control valve 30 or the bottom valve 10 with the electric control valve 30. For the piston 7 without the electric control valve 30 or the bottom valve 10 without the electric control valve 30, the change of the damping force value is not controlled by the controller 24. The piston 7 without the electric control valve 30 or the bottom valve 10 without the electric control valve 30 shall use the conventional damping valve and one-way valve 6 mounted on the piston 7 or the bottom valve 10 like the conventional single-barrel or double-barrel damper. The working mode of the piston 7 without the electric control valve 30 or the bottom valve 10 without the electric control valve 30 is the same as the working mode of the piston 7 or the bottom valve 10 of the traditional damper. As shown in FIG. 9, FIG. 10 and FIG. 11, at least one of the piston 7 and the bottom valve 10 is provided with the electric control valve 30, and both can be provided with the electric control valve 30, but not both must be provided with the electric control valve 30. The bottom valve 10 or the piston 7 without the electric control valve 30 should be additionally provided with the conventional damping valve and the conventional one-way valve 6 of the conventional single-barrel or double-barrel damper.

For the support damping apparatus shown in FIG. 9 and FIG. 10: the controller 24 calculates the current resultant force of the support spring 4 and the hydraulic cylinder 17 on the support damping apparatus according to the measured values of the force sensor A 25 and the force sensor B 26. When the resultant force is greater than the target force value, and the stress state of the hydraulic cylinder 17 is a pulling force, the control signal outputted by the controller 24 increases the damping force value of the electric control valve 30 on the piston 7 (applicable when the piston 7 is provided with the electric control valve 30), and decreases the damping force value of the electric control valve 30 on the bottom valve 10 (applicable when the bottom valve 10 is provided with the electric control valve 30). When the resultant force is greater than the target force value, and the stress state of the hydraulic cylinder 17 is the pressure, the control signal outputted by the controller 24 decreases the damping force value of the electric control valve 30 on the piston 7 (applicable when the piston 7 is provided with the electric control valve 30) and the damping force value of the electric control valve 30 on the bottom valve 10 (applicable when the bottom valve 10 is provided with the electric control valve 30).

When the resultant force is less than the target force value, and the stress state of the hydraulic cylinder 17 is a pulling force, the control signal outputted by the controller 24 decreases the damping force value of the electric control valve 30 on the piston 7 and the damping force value of the electric control valve 30 on the bottom valve 10. When the resultant force is less than the target force value, and the stress state of the hydraulic cylinder 17 is the pressure, the control signal outputted by the controller 24 decreases the damping force value of the electric control valve 30 on the piston 7 (applicable when the piston 7 is provided with the electric control valve 30) and increases the damping force value of the electric control valve 30 on the bottom valve 10 (applicable when the bottom valve 10 is provided with the electric control valve 30).

For the support damping apparatus shown in FIG. 11: the force sensor 700 measures the resultant force of the support spring 4 and the hydraulic cylinder 17. The piston 7 or (and) the bottom valve 10 is provided with both the electric control valve 30 and the one-way valve 6.

When the resultant force is less than the target force value, the control signal outputted by the controller 24 increases the damping force value of the electric control valve 30 on the piston 7 (applicable when the piston 7 is provided with the electric control valve 30) and decreases the damping force value of the electric control valve 30 on the bottom valve 10 (applicable when the bottom valve 10 is provided with the electric control valve 30).

When the resultant force is less than the target force value, the control signal outputted by the controller 24 decreases the damping force value of the electric control valve 30 on the piston 7 (applicable when the piston 7 is provided with the electric control valve 30) and increases the damping force value of the electric control valve 30 on the bottom valve 10 (applicable when the bottom valve 10 is provided with the electric control valve 30).

When the hydraulic cylinder 17 is stretched and the bottom valve 10 is provided with the electric control valve 30 and the one-way valve 6, the liquid flow flows by the one-way valve 6 on the bottom valve 10 and is not influenced by the electric control valve 30 on the bottom valve 10.

When the hydraulic cylinder 17 is compressed and the piston 7 is provided with the electric control valve 30 and the one-way valve 6, the liquid flow flows by the one-way valve 6 on the piston 7 and is not influenced by the electric control valve 30 on the piston 7.

The preferred solutions described herein are only listed partially. Any method that uses the measured force value to directly or indirectly adjust and control the damping of the damping force in a mechanical, electric or hydraulic manner or that uses the measured force value to directly or indirectly adjust and control the support force value of the object in the mechanical, electric or hydraulic manner to reduce the vibration shall all belong to the solutions that are apparent from the technical solutions used herein and shall fall within the technical scope of the patent.

What is claimed is:

1. A support damping apparatus, comprising:
a support spring (4), a force measuring element (100) and a damper (200), wherein
the damper (200) comprises a hydraulic cylinder (17), a valve assembly (300) and a control assembly (400),
wherein the force measuring element (100) is used to measure a support force value of the support damping apparatus for a supported object; the control assembly (400) is used to compare the support force value with a target force value, and control the damping force value of the valve assembly (300) in a mechanical, hydraulic or electric manner according to a comparison result so as to adjust a stretching damping force value or compression damping force value of the damper (200), so that the support force value of the support damping apparatus is equal to or approximate to the target force value;
a damping adjusting method is as follows:
when the support force value of the support damping apparatus is greater than the target force value, and the damper (200) is in a stretching process, increasing the stretching damping force value of the damper (200); and when the support force value of the support damping apparatus is less than the target force value, and the damper (200) is in the stretching process, decreasing the stretching damping force value of the damper (200);
or
when the support force value of the support damping apparatus is greater than the target force value, and the damper (200) is in a compression process, decreasing the compression damping force value of the damper (200); and when the support force value of the support damping apparatus is less than the target force value, and the damper (200) is in the compression process, increasing the compression damping force value of the damper (200).

2. The support damping apparatus according to claim 1, wherein
the control assembly (400) comprises a control linkage (1); a piston (7) of the damper (200) is integrated with the valve assembly (300); the valve assembly (300) comprises a one-way valve (6) and a slide valve (8); the slide valve (8) is connected to the control linkage (1); the force measuring element (100) comprises a force measuring spring (2);
the force measuring spring (2) is used to measure the support force value of the support damping apparatus and adjust the position of the slide valve (8) through the control linkage (1) according to a measured value, thereby adjusting the damping force value of the valve assembly (300).

3. The support damping apparatus according to claim 1, wherein
the control assembly (400) comprises a control linkage (1), and a bottom valve (10) of the damper (200) is integrated with a valve assembly (300); the valve assembly (300) comprises a one-way valve (6) and a slide valve (8); the slide valve (8) is connected to the control linkage (1); the force measuring element (100) comprises a force measuring spring (2);
the force measuring spring (2) is used to measure the support force of the support damping apparatus and adjust the damping force value of the valve assembly (300) through the control linkage (1) according to a measured value.

4. The support damping apparatus according to claim 1, wherein
the control assembly (400) comprises a control linkage (1); the piston (7) of the damper (200) is integrated with a valve assembly (300); the valve assembly (300) comprises two one-way valves (6) and a slide valve (8); one one-way valve (6) is communicated with a stretching cavity (5), and the other one-way valve (6) is communicated with a compression cavity (9); the slide valve (8) communicated with the compression cavity (9) forms a compression valve (500); the slide valve (8) communicated with the stretching cavity (5) forms a stretching valve (600); the slide valve (8) is connected to the control linkage (1); the piston (7) is provided with a piston inner cavity (31); the piston inner cavity (31) is communicated with a liquid storage device (22); the piston inner cavity (31) is communicated with the stretching cavity (5) and the compression cavity (9) through the one-way valves (6); the force measuring element (100) comprises a force measuring spring (2);
when the damper (200) is compressed or stretched, the force measuring spring (2) measures a support force value of the support damping apparatus and adjusts a damping force value of the stretching valve (600) and the compression valve (500) through the control linkage (1) according to the measured value.

5. The support damping apparatus according to claim 1, wherein
a hydraulic cylinder (17) is a single-action hydraulic cylinder (20); a support spring (4) comprises an energy storage device (19), and the valve assembly (300) comprises a pressure reducing valve (21) and a one-way valve (6); the force measuring element (100) comprises a force measuring spring (2) arranged on the pressure reducing valve (21); the control assembly (400) comprises a valve core on the pressure reducing valve (21);
wherein the energy storage device (19) is connected with an oil inlet of the pressure reducing valve (21) and an oil outlet of the one-way valve (6); the single-action hydraulic cylinder (20) is connected with an oil outlet of the pressure reducing valve (21) and an oil inlet of the one-way valve (6); when the single-action hydraulic cylinder (20) is stretched, the pressure of the liquid flow entering the single-action hydraulic cylinder (20) is compared with a set target pressure value of the pressure reducing valve (21) so as to adjust the damping force value of the pressure reducing valve (21); and when the single-action hydraulic cylinder (20) is compressed, the liquid flow in the single-action hydraulic cylinder (20) flows into the energy storage device (19) via the one-way valve (6).

6. The support damping apparatus according to claim 1, wherein
a hydraulic cylinder (17) is a single-action hydraulic cylinder (20); a support spring (4) comprises an energy storage device (19); the valve assembly (300) comprises an overflow valve (23) and a one-way valve (6); the force measuring element (100) comprises a force measuring spring (2) arranged on the overflow valve (23); the control assembly (400) comprises a valve core on the overflow valve (23);
wherein the energy storage device (19) is connected with an oil outlet of the overflow valve (23) and an oil inlet of the one-way valve (6), and the single-action hydraulic cylinder (20) is connected with an oil inlet of the overflow valve (23) and an oil outlet of the one-way valve (6); when the single-action hydraulic cylinder (20) is compressed, the pressure of the liquid flow flowing out of the single-action hydraulic cylinder (20) is compared with the target pressure value of the overflow valve (23) so as to adjust the damping force value of the overflow valve (23); and when the single-action hydraulic cylinder (20) is stretched, the liquid flow in the energy storage device (19) flows to the single-action hydraulic cylinder (20) via the one-way valve (6).

7. The support damping apparatus according to claim 1, wherein
the force measuring element (100) comprises a force sensor (700); the control assembly (400) comprises a controller (24); the valve assembly (300) comprises an electric control valve (30);
wherein at least one of the piston (7) and the bottom valve (10) of the damper (200) is provided with an electric control valve (30);
when the piston (7) or the bottom valve (10) of the damper (200) is provided with a one-way valve (6), at least one force sensor (700) should be mounted to measure a resultant force of the support damping apparatus;
when the piston (7) or the bottom valve (10) of the damper (200) is not provided with the one-way valve, at least two force sensors (700) should be mounted to measure the resultant force of the support damping apparatus and calculate whether a stress state of the damper (200) is a pulling force or pressure;
the controller (24) compares the resultant force of the support damping apparatus measured by the force sensor (700) with the target force value and controls the damping force value of the electric valve (30) according to a comparison result and the stress state of the damper (200).

8. The support damping apparatus according to claim 7, wherein
the force sensor (700) comprises a force sensor A(25) for measuring a support force value of a support spring (4) and a force sensor B(26) for measuring a pulling force or pressure value of the hydraulic cylinder (17);
wherein a current resultant force of the support spring (4) and the hydraulic cylinder (17) on the support damping apparatus is calculated through measured values of the force sensor A(25) and the force sensor B(26), and a stress state of the hydraulic cylinder (17) is judged; and the controller (24) controls the damping force value of an electric control valve (30) according to the resultant force of the support damping apparatus and the stress state of the hydraulic cylinder (17).

9. The support damping apparatus according to claim 7, wherein the valve assembly (300) comprises an electric control valve (30) and a one-way valve (6); the electric control valve (30) and the one-way valve (6) are mounted on the piston (7) of the damper (200), wherein the one-way valve (6) on the piston (7) is connected with the electric control valve (30) in parallel; the force sensor (700) measures a resultant force of the support spring (4) and the hydraulic cylinder (17) on the support damping apparatus; the controller (24) compares the resultant force of the support damping apparatus measured by the force sensor (700) with the target force value and controls the damping force value of the electric control valve (30) according to a comparison result.

10. A vehicle, using the support damping apparatus of claim 1.

11. A vehicle, using the support damping apparatus of claim 2.

12. A vehicle, using the support damping apparatus of claim 5.

13. A vehicle, using the support damping apparatus of claim 6.

14. A vehicle, using the support damping apparatus of claim 7.
